(19) United States
(12) Patent Application Publication
(10) Pub. No.: US 2026/0101912 A1
(43) Pub. Date: Apr. 16, 2026

(54) INDUCTION COOKER

(71) Applicant: Kenyon International, Inc., Clinton, CT (US)

(72) Inventors: Daniel Roy, Westerly, RI (US); Michael Reischmann, Eustis, FL (US); Philip Williams, Clinton, CT (US)

(21) Appl. No.: 19/355,970

(22) Filed: Oct. 10, 2025

Related U.S. Application Data
(60) Provisional application No. 63/706,112, filed on Oct. 11, 2024.

(51) Int. Cl. A23L 7/187; H02K 33/18; H05B 6/10; H05B 6/12

(52) U.S. Cl. CPC A23L 7/187; H02K 33/18; H05B 6/105; H05B 6/12; H05B 2213/05

(57) ABSTRACT

A cooking apparatus, namely an induction cooker is provided. Preferably the cooker is provided to cook in single use vessels which are relatively lightweight and inexpensive. The cooker includes a vibration mechanism to stir the food while cooking and an induction coil (which may itself cause the vibrations and thus be the vibration mechanism). In some aspects the vibration mechanism is provided above the induction coil and the size of the induction coil relative to the vessel is such that the vessel blocks the magnetic field generated by the induction coil from impacting the operation of the vibration mechanism.

### FIELD OF THE INVENTION

The present disclosure relates to an induction cooking apparatus, more specifically to a single serve induction cooking apparatus that uses induction and vibration to cook food in a single use vessel, for example popcorn.

### BACKGROUND

Induction is a fast and effective way to cook food, but has typically been reserved for use with re-useable cooking vessels which require cleaning. Many people prefer single use items that can be disposed of after use for a convenient meal or snack. However, these items are primarily cooked in a microwave. Microwave cooking often does not provide the same flavor or crisp cooking as stovetop cooking. Microwave cooking also typically includes a rotating turntable to help provide more even cooking. Stovetop cooking usually relies on mixing/stirring to allow for even cooking.

One example of a snack that many enjoy is popcorn. Often popcorn will be sold in pre-packaged microwaveable bags with various flavors and preservatives. The taste of popcorn cooked on the stovetop and in oil is normally found to be more desirable by most people. However, stovetop cooking of popcorn requires more attention and skill than microwave cooking. Thus, it would be beneficial if cooking could be accomplished in a relatively automated manner.

Thus, a convenient way to cook single use food is desired which provides the convenience of a microwave but the taste and benefits of stovetop cooking.

### SUMMARY

The following presents a simplified summary of the claimed subject matter in order to provide a basic understanding of some aspects of the claimed subject matter. This summary is not an extensive overview of the claimed subject matter. It is intended to neither identify key or critical elements of the claimed subject matter nor delineate the scope of the claimed subject matter. Its sole purpose is to present some concepts of the claimed subject matter in a simplified form as a prelude to the more detailed description that is presented later.

The cooking apparatus described hereinbelow, according to various embodiments, addresses various challenges facing previously employed single use cooking devices. A particular advantage of the present system is that the vibration mechanism can be placed above the induction coil and that the cartridge or vessel can be inserted and retained in a manner that avoids the cartridge from being lifted out of the cooking apparatus during activation of the induction coil (e.g. due to magnetism) lid and latch systems. The arrangement of the vibration mechanism above the induction coil allows the vibration mechanism to more directly vibrate the cooking vessel.

Furthermore, as single use cartridges are made from less expensive materials and/or are made from less materials to reduce cost, there is a concern that the magnetic forces generated by the induction coil can lift away the vessel, thus the present device also allows for a mechanical retention of the cooking vessel that is easy to operate and retains the single use vessel in a simple to use manner.

For example, in one aspect, a cooking device for cooking in a removable vessel is provided including a housing and a heating element in the housing. A receiver is supported by the housing and is configured to receive the removable vessel therein. The heating element, when activated, is configured to heat the removable vessel when the removable vessel is in the receiver. A vibrator is configured to vibrate the removable vessel when the removable vessel is in the receiver. A retainer is arranged above the receiver and attached to the housing. The retainer is made of a different material than the housing and has an opening wherein the opening is sized smaller than an outer dimension of the removable vessel. When the removable vessel is positioned in the receiver and below the retainer, a gap exists between a lower portion of the retainer and an upper portion of the removable vessel. The removable vessel is inserted into the receiver through the opening, such that at least part of the retainer is forced to increase a size of the opening to allow the removable vessel to pass through the opening and wherein after passing through the opening the removable vessel is inhibited from removal by the retainer.

In certain aspects, the lower portion of the retainer is arranged above an upper portion of the receiver. In further aspects, the heating element is an induction heating element. In still further aspects, the vibrator is positioned above the induction heating element. In still further aspects, the vibrator includes a coil and magnet. In still further aspects, the coil and magnet are positioned to vibrate the receiver and further positioned such that each straight path drawn from an outermost portion of an induction coil of the induction heating element to the vibrator passes through the removable vessel when the removable vessel is installed in the receiver. In yet further aspects, the heating element is an induction heating element which is configured to generate heat in a non-ferromagnetic material. In still other aspects, at least part of the vibrator is positioned in a recess of a sidewall of the receiver.

In other aspects, a cooking device for cooking in a removable vessel is provided with a housing and an induction heating element in the housing. A receiver is supported by the housing and is configured to receive the removable vessel therein. The induction heating element, when activated, is configured to heat the removable vessel when the removable vessel is in the receiver. A vibrator is configured to vibrate the removable vessel when the removable vessel is in the receiver wherein the vibrator is positioned above the induction heating element.

In certain aspects, a retainer is arranged above the receiver and attached to the housing, the retainer being made of a different material than the housing and having an opening wherein the opening is sized smaller than an outer dimension of the removable vessel and wherein, when the removable vessel is positioned in the receiver and below the retainer, a gap exists between a lower portion of the retainer and an upper portion of the removable vessel. In still other aspects, the vibrator includes a coil and magnet. In yet other aspects, the coil and magnet are positioned to vibrate the receiver and further positioned such that each straight path drawn from an outermost portion of an induction coil of the induction heating element to the vibrator passes through the removable vessel when the removable vessel is installed in the receiver. In further aspects, the removable vessel substantially blocks an oscillating field —-generated by the induction coil when the induction heating element is activated —-from interacting with the coil and magnet of the vibrator.

In still other aspects, a cooking device is provided for cooking food items in a removable vessel, the cooking device includes a housing and an induction heating element in the housing. A receiver is supported by the housing and is configured to receive the removable vessel therein, the heating element, when activated, is configured to heat the removable vessel when the removable vessel is in the receiver. A controller is configured to induce a magnetic field at or above the induction heating element and to induce current, the magnetic field and current vibrating the removable vessel.

In certain aspects, a vibrator is configured to vibrate the removable vessel when the removable vessel is in the receiver. In yet other aspects, the controller is configured to activate the vibrator or the induction heating element upon activation of the cooking device to cause the removable vessel to move away from the receiver and the controller measures a change in measured impedance. Based on the change in measured impedance, the controller determines whether to activate a cooking program for the induction heating element. In still other aspects, the controller activates the cooking device to generate a Lenz force to stir the food items to be cooked in the removable vessel. In still other aspects, the controller activates the cooking device to generate a Lorentz force to stir the food items to be cooked in the removable vessel.

### DRAWINGS

FIG. 1 shows a cross section view of a cooking apparatus according to various embodiments.

FIG. 2 is a detailed view of FIG. 1.

FIG. 3 is a further detailed view of FIG. 2.

FIG. 4 is a perspective view of the cooking/vibrating assembly of FIG. 1 with the vessel inserted therein.

FIG. 5 shows FIG. 4 with the vessel removed.

### DETAILED DESCRIPTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

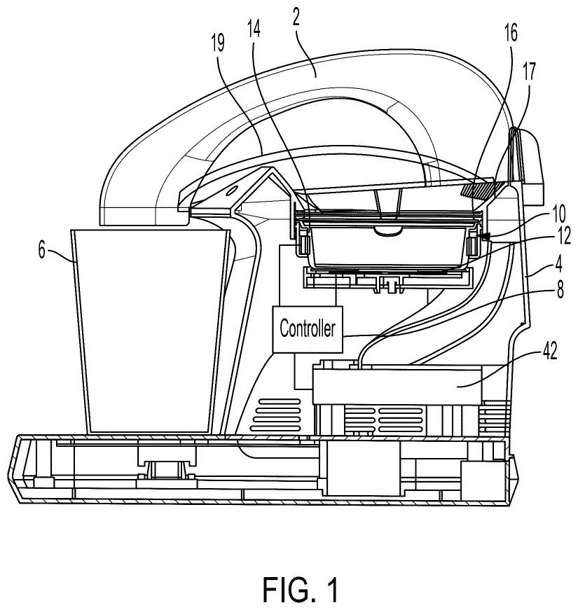

As shown in FIG. 1, an induction cooking apparatus is shown. In the particular embodiment, a popcorn cooker is provided with a housing 4 and a hinged lid 2 along with a receiving cup 6. Within the housing, a support 14 for a cooking vessel is provided. In preferred embodiments the material used for the support 14 is flexible and/or elastomeric, for example silicone rubber or another similar material. Preferably a non-metallic and non-conductive material is used for the support 14. The induction coil 12 is positioned below the support 14. A vibration device 10 is positioned above the induction coil 12. A controller 8 is provided within the housing 4 and is connected to the vibration device 10, the fan 42 and the induction coil 12. As needed, the controller 8 coordinates operation between the vibrator 10, the fan 42 and the coil 12 in order to cook the food, in this example, popcorn.

At the upper end of the support 14 is a retaining device 16 which is provided to hold the vessel in place during operation of the cooking cycle.

The fan 42 is operated, sometimes during cooking, in order to assist the popped kernels in moving towards the serving cup 6. The fan blows air out the vent 17, generally along the path 19 to assist in this movement of the popped kernels.

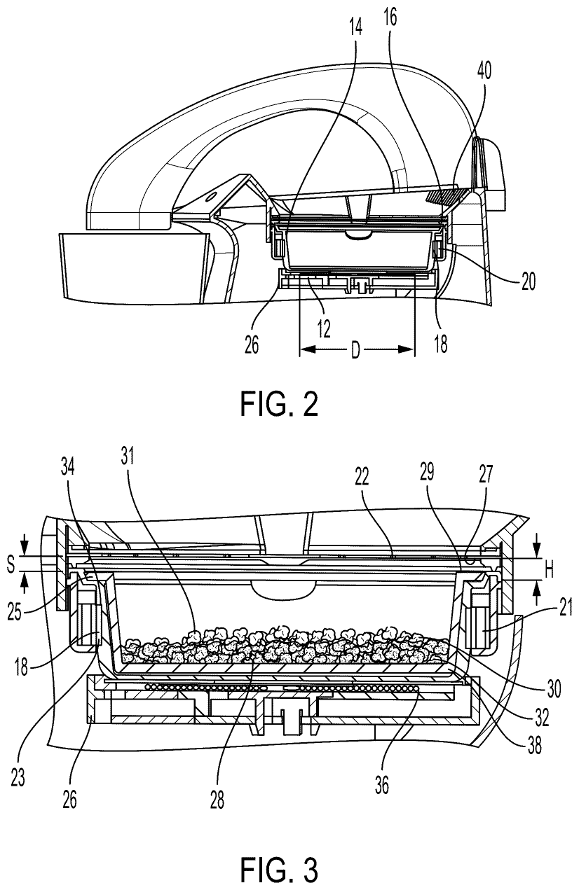

As can be seen in FIGS. 2 and 3, a support 26 is provided for the induction coil 12. This support 26 holds the coil 12 in close proximity to the underside of the support 14 for the vessel 28. The width (or diameter) D of the coil 12 is less than that of the support 14. Notably, the support 14 is sized to receive the vessel 28 therein and thus when inserted into the support 14, the vessel 28 blocks the pathway from the outermost portion of the coil 36 to the lower portion of the vibrator apparatus 10, particularly the coil/magnet of the vibrator 10. Notably, the lower and outer portion 38 of the vessel 28 is positioned along a path (ideally along the straight path) between the outermost portion 36 and the lowermost portion 23. Since the vessel 28 is made of a conductive material, its presence blocks or inhibits the magnetic field generated by the induction coil 12 from impacting the vibrator 10.

The vibrator 10 is a combination of two parts 18/21, namely a coil 21 and magnet 18. The support 14 includes a recess 34 in its outer surface. The magnet 18 fits in this recess 34 so that as the coil 21 is activated by the controller 8, the magnet 18 moves up and down to vibrate the support 14 which thereby vibrates the vessel 28. As shown, the vessel is provided with a combination of popcorn 30, seasoning 31 and a cooking fat such as oil 32.

As can be seen, the retainer 16 is positioned above the support 14 such that a lower portion 27 of the retainer 16 is spaced a distance H away from the surface 25 of the support 14. This surface 25 is sized to mate with a lower surface of a flange/ring/lip 29 on an outer side of the vessel. The upper surface of the flange/ring/lip 29 is then spaced distance S away from the lower surface 27 of the retainer 16. In this manner, the vessel 28 can float slightly when a magnetic field is generated by the coil 12. This floating allows the vessel 28 to move away from the coil 12 and as a result, the combined inductance of the coil 12 and vessel 28 changes based on how far the vessel floats away. This change in inductance can indicate that the vessel 28 is empty when cooking is finished or can be used to determine the weight of the vessel 28 when full (or when part way through cooking) in order to determine how much time is needed to cook the popcorn and/or what cooking program is used by the controller 8. In preferred aspects, the distance H is 1.1-3 times that of distance S, preferably 1.2-2.5, more preferably 1.3-2.25.

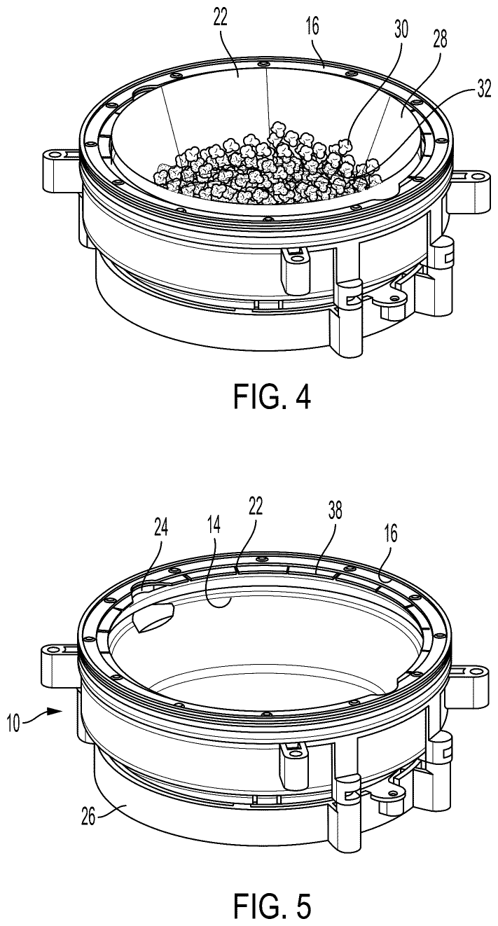

As can be seen in FIGS. 4-5, the vessel 28 is installed in the support 12 and the retainer 16 of includes slits 22 which increase the flexibility of the fingers 38 to allow those fingers 38 to flex as the vessel 28 is inserted past the opening of the retainer 16. As can be seen, the retainer inner diameter is less than the outer diameter of the flange/ring/lip 29 of the vessel 28. A cutout 24 is provided in the retainer 16 to enable the user to remove the vessel 28 when finished. In preferred embodiments, the retainer 16 is made of a different material than the housing 4 and/or a different material than the support 14. Notably, the retainer 16 is more rigid than the elastomeric/rubber/silicone material of the support 14.

Lenz and/or Lorentz forces can be generated to vibrate the cooking vessel. In some cases, the induction coil 12 may be controlled by the controller 8 in a way that generates a Lorentz force, causing the vessel 28 to move up and down. As one of skill in the art will appreciate, the Lorentz force is the combination of electric and magnetic forces on a point charge due to electromagnetic fields. A Lenz force may be generated by activating the vibrator coil 21 to force the magnet 18 to move, thus causing vibration of the vessel 28. Lenz's law states that the current induced in a circuit due to a change in a magnetic field is directed to oppose the change in flux and to exert a mechanical force which opposes the motion. This mechanical force can be used to move the vessel 28 to cause vibrations.

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting.

What is claimed is:

1. A cooking device for cooking in a removable vessel comprising:
a housing;
a heating element in the housing;
receiver supported by the housing and configured to receive the removable vessel therein, the heating element, when activated, configured to heat the removable vessel when the removable vessel is in the receiver;
a vibrator configured to vibrate the removable vessel when the removable vessel is in the receiver; and
a retainer arranged above the receiver and attached to the housing, the retainer made of a different material than the housing and having an opening wherein the opening is sized smaller than an outer dimension of the removable vessel and wherein when the removable vessel is positioned in the receiver and below the retainer a gap exists between a lower portion of the retainer and an upper portion of the removable vessel.

2. The device of claim 1 wherein when the removable vessel is inserted into the receiver through the opening, at least part of the retainer is forced to increase a size of the opening to allow the removable vessel to pass through the opening and wherein, after passing through the opening, the removable vessel is inhibited from removal by the retainer.

3. The device of claim 1 wherein the lower portion of the retainer is arranged above an upper portion of the receiver.

4. The device of claim 1 wherein the heating element is an induction heating element.

5. The device of claim 1 wherein the vibrator is positioned above the induction heating element.

6. The device of claim 4 wherein the vibrator includes a coil and magnet.

7. The device of claim 6 wherein the coil and magnet are positioned to vibrate the receiver and further positioned such that each straight path drawn from an outermost portion of an induction coil of the induction heating element to the vibrator passes through the removable vessel when the removable vessel is installed in the receiver.

8. The device of claim 1 wherein the heating element is an induction heating element which is configured to generate heat in a non-ferromagnetic material.

9. The device of claim 1 wherein at least part of the vibrator is positioned in a recess of a sidewall of the receiver.

10. A cooking device for cooking in a removable vessel comprising:
a housing;
an induction heating element in the housing; and
a receiver supported by the housing and configured to receive the removable vessel therein, the induction heating element, when activated, configured to heat the removable vessel when the removable vessel is in the receiver;
a vibrator configured to vibrate the removable vessel when the removable vessel is in the receiver, wherein the vibrator is positioned above the induction heating element.

11. The device of claim 10 further comprising:
a retainer arranged above the receiver and attached to the housing, the retainer made of a different material than the housing and having an opening wherein the opening is sized smaller than an outer dimension of the removable vessel and wherein, when the removable vessel is positioned in the receiver and below the retainer, a gap exists between a lower portion of the retainer and an upper portion of the removable vessel.

12. The device of claim 10 wherein the vibrator includes a coil and magnet.

13. The device of claim 12 wherein the coil and magnet are positioned to vibrate the receiver and further positioned such that each straight path drawn from an outermost portion of an induction coil of the induction heating element to the vibrator passes through the removable vessel when the removable vessel is installed in the receiver.

14. The device of claim 13 wherein the removable vessel substantially blocks an oscillating field generated by the induction coil when the induction heating element is activated from interacting with the coil and magnet of the vibrator.

15. A cooking device for cooking food items in a removable vessel comprising:
a housing;
an induction heating element in the housing;
a receiver supported by the housing and configured to receive the removable vessel therein, the heating element, when activated, configured to heat the removable vessel when the removable vessel is in the receiver; and
a controller configured to induce a magnetic field at or above the induction heating element and to induce current, the magnetic field and current vibrating the removable vessel.

16. The cooking device of claim 15 further comprising: a vibrator configured to vibrate the removable vessel when the removable vessel is in the receiver.

17. The cooking device of claim 16 wherein the controller is configured to activate the vibrator or the induction heating element upon activation of the cooking device to cause the removable vessel to move away from the receiver, the controller measuring a change in measured impedance and, based on the change in measured impedance, the controller determines whether to activate a cooking program for the induction heating element.

18. The cooking device of claim 15 wherein the controller activates the cooking device to generate a Lenz force to stir the food items to be cooked in the removable vessel.

19. The cooking device of claim 15 wherein the controller activates the cooking device to generate a Lorenz force to stir the food items to be cooked in the removable vessel.
